(19) United States
(12) Patent Application Publication
(10) Pub. No.: US 2026/0154020 A1
(43) Pub. Date: Jun. 4, 2026

(54) PRINT CONTROL APPARATUS, PRINT CONTROL METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Yoshiaki MIZOUCHI, Shiojiri (JP)

(21) Appl. No.: 19/405,503

(22) Filed: Dec. 2, 2025

(30) Foreign Application Priority Data
Dec. 4, 2024 (JP) 2024-211208

(51) Int. Cl. G06F 3/12

(52) U.S. Cl. CPC G06F 3/1262; G06F 3/1205; G06F 3/1287

(57) ABSTRACT

A control section is a control section that controls combined printing of a plurality of documents and includes: a first setting processing section configured to set, in regard to a first setting item, which is a setting item included in a first category, from among a plurality of setting items defining content of processing to be performed on the documents, a setting value of the first setting item of any one document from among the plurality of documents for the first setting item of each of the plurality of documents; and a second setting processing section configured to set, in regard to a second setting item, which is a setting item included in a second category that is different from the first category, from among the plurality of setting items, a default value of the second setting item for the second setting item of each of the plurality of documents.

The present application is based on, and claims priority from JP Application Serial Number 2024-211208, filed Dec. 4, 2024, the disclosure of which is hereby incorporated by reference herein in its entirety.

### BACKGROUND

### 1. Technical Field

The present disclosure relates to a print control apparatus, a print control method, and a non-transitory computer-readable storage medium storing a program.

### 2. Related Art

JP-A-2009-259021 discloses the following content.

Documents created by personal computers, images read by scanners, and the like are accumulated in a printer, and a plurality of accumulated documents are printed in a combined manner as one document. In a case where mutually contradictory print settings are designated for each of the plurality of documents and the like to be combined and printed, it is necessary to change the print setting of some of the documents and the like to be combined. In the case where the mutually contradictory print settings are designated for the documents and the like to be printed in a combined manner, selection of setting items for the contradictory print settings is enabled.

However, according to the technique described in JP-A-2009-259021, any one of the contradictory settings is selected in the combined printing, and an output result that is different from that in a case where each of the plurality of documents is individually output is thus obtained. Therefore, there is a problem that a printing result desired by a user may not be obtained.

### SUMMARY

A print control apparatus according to an aspect to solve the above problem is a print control apparatus that controls combined printing of a plurality of documents, the print control apparatus including: a first setting processing section configured to set, in regard to a first setting item, which is a setting item included in a first category, from among a plurality of setting items defining content of processing to be performed on the documents, a setting value of the first setting item of any one document from among the plurality of documents for the first setting item of each of the plurality of documents; and a second setting processing section configured to set, in regard to a second setting item, which is a setting item included in a second category that is different from the first category, from among the plurality of setting items, a default value of the second setting item for the second setting item of each of the plurality of documents.

### BRIEF DESCRIPTION OF THE DRAWINGS

FIG. 1 is a diagram illustrating an example of a configuration of a printer according to the present embodiment.

FIG. 2 is a diagram illustrating an example of a configuration of a control section according to the present embodiment.

FIG. 3 is a diagram illustrating an example of setting items included in a first category.

FIG. 4 is a diagram illustrating an example of setting items included in a second category or a third category.

FIG. 5 is a diagram illustrating an example of processing conditions and processing results in a case of individual printing.

FIG. 6 is a diagram illustrating an example of processing conditions and processing results in a case of combined printing.

FIG. 7 is a flowchart illustrating an example of processing performed by the control section.

### DESCRIPTION OF EMBODIMENTS

Hereinafter, the present embodiment will be described with reference to the drawings.

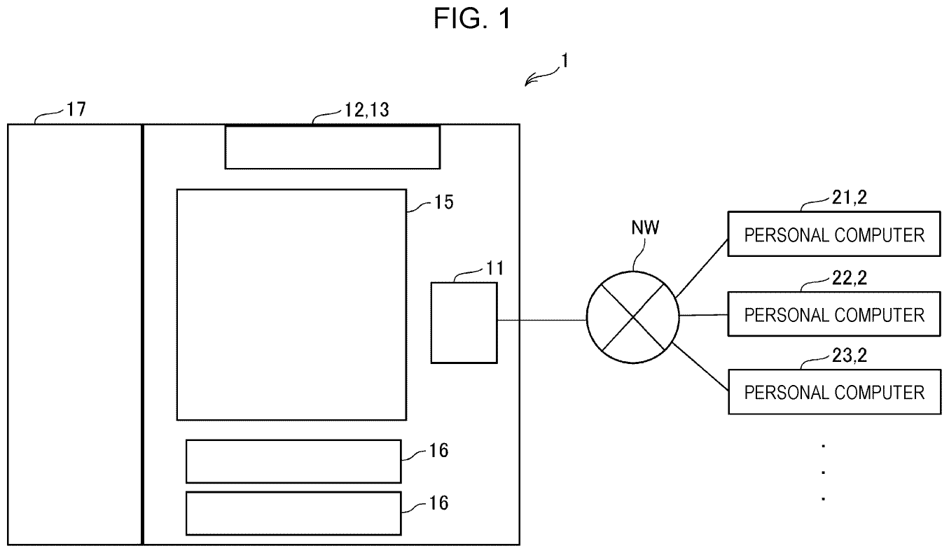

First, a configuration of a printer 1 according to the present embodiment will be described with reference to FIG. 1. FIG. 1 is a diagram illustrating an example of a configuration of the printer 1 according to the present embodiment.

As illustrated in FIG. 1, the printer 1 is communicably connected to a plurality of personal computers 2 via a network NW.

The network NW is, for example, a local area network (LAN).

The plurality of personal computers 2 include, for example, a first personal computer 21, a second personal computer 22, and a third personal computer 23.

Each of the plurality of personal computers 2 stores document data DD in a document storage section 117 of a memory 11B of the printer 1 in accordance with an instruction from a user.

In addition, each of the plurality of personal computers 2 provides an instruction for combined printing to the printer 1 in accordance with an instruction from the user, for example. The “combined printing” means that a plurality of pieces of document data DD stored in the document storage section 117 is printed as one job. Note that the printing of the document data DD stored in the document storage section 117 corresponds to an example of so-called “box printing”. In other words, the “combined printing” in the present embodiment corresponds to “combined printing” in the “box printing”.

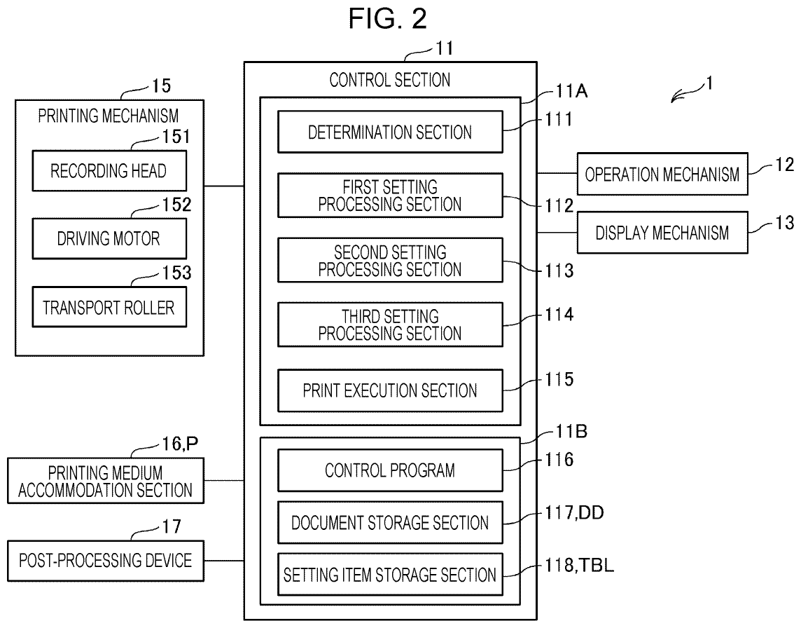

The document storage section 117 will be further described with reference to FIG. 2.

The printer 1 includes a control section 11, an operation mechanism 12, a display mechanism 13, a printing mechanism 15, a printing medium accommodation section 16, and a post-processing device 17.

The control section 11 controls operations of each section of the printer 1. Each of the operation mechanism 12, the display mechanism 13, the printing mechanism 15, the printing medium accommodation section 16, and the post-processing device 17 is configured to be able to communicate with the control section 11.

The operation mechanism 12 is disposed at an upper portion of the printer 1. The operation mechanism 12 includes an input unit such as an operation switch or a touch panel provided in the printer 1, detects a user's operation on the input unit, and outputs a detection signal corresponding to the operation to the control section 11. The control section 11 executes processing corresponding to the user's operation on the basis of an input from the operation mechanism 12.

The display mechanism 13 is disposed at the upper portion of the printer 1. The display mechanism 13 includes a plurality of light emitting diodes (LEDs) and a display panel such as a liquid crystal display (LCD) and executes turning-on, turning-off, and blinking of the LEDs in predetermined modes, display of information on the display panel, and the like under control of the control section 11.

The printing mechanism 15 executes a printing function under control of the control section 11. The printing mechanism 15 prints characters, images, and the like on recording media P such as printing paper under control of the control section 11.

The configuration of the printing mechanism 15 will be further described with reference to FIG. 2.

The printing medium accommodation section 16 is configured to be able to accommodate the recording media P. As for the printing medium accommodation section 16, sheet-shaped recording media P, for example, are stacked and accommodated in the printing medium accommodation section 16. The printing medium accommodation section 16 feeds the recording medium P disposed at the uppermost position among the stacked sheet-shaped recording media P to a transport path, which is not illustrated, under control of the control section 11.

The post-processing device 17 performs post-processing on the recording media P on which printing has been performed by the printing mechanism 15. The post-processing device 17 includes, for example, a stapler, a puncher, and a sorter.

The stapler stacks the recording media P for each set and staples end portions of the recording media P on one side for each set. Each set is constituted by a plurality of recording media P.

The puncher punches a punch hole at an end portion of each recording medium P on one side.

The sorter performs processing of stacking the recording media P for each set.

Next, a configuration of the control section 11 will be described with reference to FIG. 2. FIG. 2 is a diagram illustrating an example of the configuration of the control section 11 according to the present embodiment.

The control section 11 includes a processor 11A such as a central processing unit (CPU) and the memory 11B such as a read only memory (ROM). The memory 11B stores a control program 116.

The control section 11 corresponds to an example of the “print control apparatus”.

The processor 11A may be constituted by a plurality of processors or may be constituted by a single processor.

The processor 11A may be hardware programmed to implement functions of each section described below. In other words, the processor 11A may have a configuration in which the control program 116 is mounted as a hardware circuit. In this case, the processor 11A is configured by, for example, an application specific integrated circuit (ASIC), a field-programmable gate array (FPGA), or the like.

In the following description, a case where various functions of the control section 11 are implemented by the processor 11A executing the control program 116 will be described.

The memory 11B has a non-volatile storage region for storing programs and data in a non-volatile manner. The memory 11B may include, for example, a ROM, a hard disk drive (HDD), a solid state drive (SSD), or the like as a non-volatile storage region. In addition, the memory 11B may include a volatile storage region and constitute a work area for temporarily storing programs to be executed by the processor 11A and data to be processed. The memory 11B may include, for example, a random access memory (RAM) as the volatile storage region.

Although the processor 11A controls each section of the printer 1 by executing the control program 116 in the present embodiment, the present disclosure is not limited thereto. The control section 11 may include, for example, an ASIC, and the ASIC may execute processing by implemented functions. In addition, the control section 11 may include, for example, a signal processing circuit, and the signal processing circuit may perform signal processing to execute processing.

As illustrated in FIG. 2, the printing mechanism 15 includes a recording head 151, a driving motor 152, and a transport roller 153 as configurations related to printing.

The recording head 151 is, for example, an ink jet recording head. In other words, the printer 1 is an ink jet printer in the present embodiment. The recording head 151 forms an image on the recording medium P by ejecting ink toward the recording medium P.

The driving motor 152 drives the transport roller 153. The driving motor 152 is, for example, a DC motor.

The transport roller 153 transports the recording medium P from the printing medium accommodation section 16 toward the recording head 151. The transport roller 153 transports the recording medium P on which an image has been formed by the recording head 151 to the post-processing device 17.

Next, functional blocks included in the control section 11 of the printer 1 will be described.

The control section 11 includes a determination section 111, a first setting processing section 112, a second setting processing section 113, a third setting processing section 114, a print execution section 115, the document storage section 117, and a setting item storage section 118.

The processor 11A functions as the determination section 111, the first setting processing section 112, the second setting processing section 113, the third setting processing section 114, and the print execution section 115 by the processor 11A executing the control program 116. Also, the processor 11A causes the memory 11B to function as the document storage section 117 and the setting item storage section 118 by executing the control program 116.

The control program 116 corresponds to an example of the “program”.

The document storage section 117 stores a plurality of pieces of document data DD.

The document storage section 117 is divided into a plurality of areas. A user is set for each of the plurality of areas. For example, a user of the first personal computer 21 is set for the first area. For example, a user of the second personal computer 22 is set for the second area. For example, a user of the third personal computer 23 is set for the third area.

The plurality of pieces of document data DD is stored in each of the first area, the second area, and the third area. Each of the first area, the second area, and the third area corresponds to a so-called “box”.

For example, the user of the first personal computer 21 selects a plurality of documents DC to be subjected to combined printing from among the plurality of pieces of document data DD stored in the first area. Then, the user of the first personal computer 21 provides an instruction to execute combined printing of the plurality of selected documents DC to the printer 1.

For example, the user of the second personal computer 22 selects a plurality of documents DC to be subjected to combined printing from among the plurality of pieces of document data DD stored in the second area. Then, the user of the second personal computer 22 provides an instruction to execute combined printing of the plurality of selected documents DC to the printer 1.

For example, the user of the third personal computer 23 selects a plurality of documents DC to be subjected to combined printing from among the plurality of pieces of document data DD stored in the third area. Then, the user of the third personal computer 23 provides an instruction to execute combined printing of the plurality of selected documents DC to the printer 1.

The document data DD is generated via various application programs installed in the personal computers 2. Furthermore, the document data DD is generated by an image reading apparatus, that is, a so-called scanner.

The document data DD includes setting value data of a plurality of setting items JS that define content of processing to be performed by the printer 1. The processing to be performed by the printer 1 includes print processing and post-processing.

The setting item storage section 118 stores, as a table TBL, for example, which of a first setting item JS1, a second setting item JS2, or a third setting item JS3 each of the plurality of setting items JS defining the content of the processing to be performed by the printer 1 is.

The first setting item JS1 is a setting item JS included in a first category CT1. The second setting item JS2 is a setting item JS included in a second category CT2. The third setting item JS3 is a setting item JS included in a third category CT3.

Also, in a case where a setting item JS is a second setting item JS2, the setting item storage section 118 stores, as the table TBL, a default value DF of the setting value of the setting item JS.

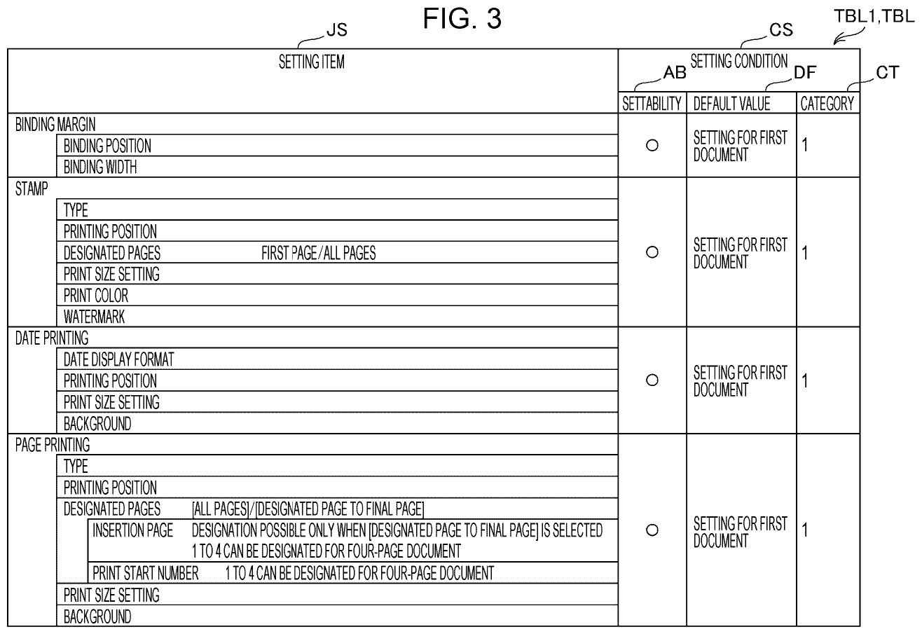

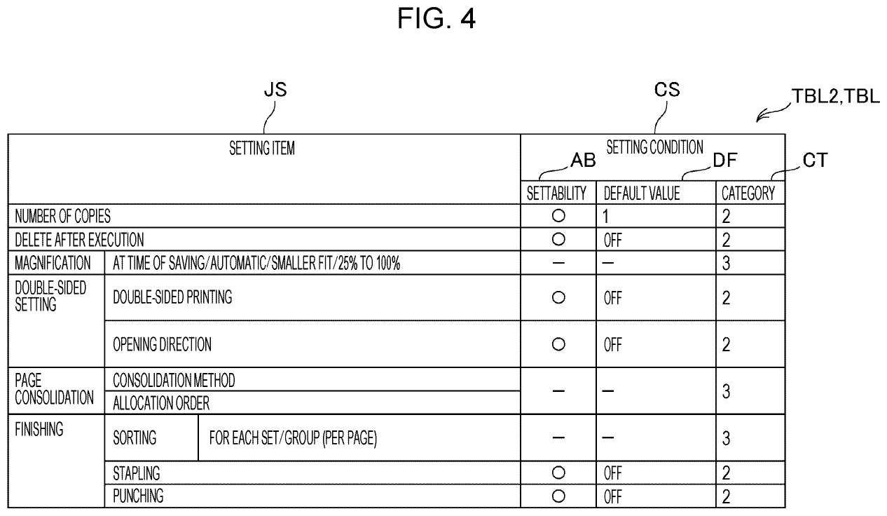

The table TBL will be further described with reference to FIGS. 3 and 4.

The determination section 111 determines, with reference to the table TBL stored in the setting item storage section 118, which of the first setting item JS1, the second setting item JS2, and the third setting item JS3 each of the plurality of setting items JS defining the content of the processing to be performed by the printer 1 is.

The first setting item JS1 is a setting item JS included in the first category CT1. The second setting item JS2 is a setting item JS included in the second category CT2. The third setting item JS3 is a setting item JS included in the third category CT3.

In a case where a setting item JS is a first setting item JS1, the first setting processing section 112 sets a setting value of the first setting item JS1 of any one document DC from among the plurality of documents DC for the first setting item JS1 of each of the plurality of documents DC.

The first setting processing section 112 sets, for the first setting item JS1 of each of the plurality of document DC, a setting value of the first setting item JS1 of a document DC that a user of the personal computer 2 has selected at the very beginning when, for example, selecting a plurality of documents DC to be subjected to combined printing.

Processing of the first setting processing section 112 in a case where the plurality of documents DC is constituted by a first document DCA, a second document DCB, and a third document DCC, for example, will be described.

In a case where the user of the personal computer 2 has selected the first document DCA at the very beginning when selecting a plurality of documents DC to be subjected to combined printing, the first setting processing section 112 performs the following processing. In other words, the first setting processing section 112 sets the setting value of the first setting item JS1 in the document data DD corresponding to the first document DCA for the first setting item JS1 of each of the first document DCA, the second document DCB, and the third document DCC.

In a case where the user of the personal computer 2 has selected the second document DCB at the very beginning when selecting a plurality of documents DC to be subjected to combined printing, the first setting processing section 112 performs the following processing. In other words, the first setting processing section 112 sets the setting value of the first setting item JS1 in the document data DD corresponding to the second document DCB for the first setting item JS1 of each of the first document DCA, the second document DCB, and the third document DCC.

In a case where the user of the personal computer 2 has selected the third document DCC at the very beginning when selecting a plurality of documents DC to be subjected to combined printing, the first setting processing section 112 performs the following processing. In other words, the first setting processing section 112 sets the setting value of the first setting item JS1 in the document data DD corresponding to the third document DCC for the first setting item JS1 of each of the first document DCA, the second document DCB, and the third document DCC.

The first setting items JS1 will be further described with reference to FIG. 3.

In a case where a setting item JS is a second setting item JS2, the second setting processing section 113 sets the setting value of the second setting item JS2 of each of the plurality of documents DC selected to be subjected to combined printing to a default value DF of the second setting item JS2.

Processing of the second setting processing section 113 in a case where the plurality of documents DC is constituted by the first document DCA, the second document DCB, and the third document DCC, for example, will be described.

The second setting processing section 113 sets the default value DF of the second setting item JS2 as the setting value of the second setting item JS2 of each of the first document DCA, the second document DCB, and the third document DCC.

The second setting items JS2 will be further described with reference to FIG. 4.

In a case where a setting item JS is a third setting item JS3, the third setting processing section 114 holds the setting value of the third setting item JS3 of each of the plurality of documents DC.

Processing of the third setting processing section 114 in a case where the plurality of documents DC is constituted by the first document DCA, the second document DCB, and the third document DCC, for example, will be described.

The third setting processing section 114 holds the setting value of the third setting item JS3 of each of the first document DCA, the second document DCB, and the third document DCC.

In other words, the third setting processing section 114 holds the setting value of the third setting item JS3 in the document data DD corresponding to the first document DCA as the setting value of the third setting item JS3 when the first document DCA is processed in the combined printing. Also, the third setting processing section 114 holds the setting value of the third setting item JS3 in the document data DD corresponding to the second document DCB as the setting value of the third setting item JS3 when the second document DCB is processed in the combined printing. Moreover, the third setting processing section 114 holds the setting value of the third setting item JS3 in the document data DD corresponding to the third document DCC as the setting value of the third setting item JS3 when the third document DCC is processed in the combined printing.

The third setting items JS3 will be further described with reference to FIG. 4.

Although a case where the third setting processing section 114 holds the setting value of the third setting item JS3 of each of the plurality of documents DC will be described in the present embodiment, embodiments are not limited thereto.

For example, the third setting processing section 114 may set the setting value of the third setting item JS3 of each of the plurality of documents DC on the basis of a user's operation.

For example, the third setting processing section 114 may select whether to set the setting value of the third setting item JS3 on the basis of the user's operation, whether to set the setting value of the third setting item JS3 to a default value of the third setting item JS3, or whether to hold the setting value of the third setting item JS3 of each of the plurality of documents DC.

The print execution section 115 uses the setting value of the first setting item JS1, the setting value of the second setting item JS2, and the setting value of the third setting item JS3, which are set by the first setting processing section 112, the second setting processing section 113, and the third setting processing section 114, to execute the combined printing of the plurality of documents DC.

Note that the setting value of the first setting item JS1 is set for each of the plurality of documents DC by the first setting processing section 112. The setting value of the second setting item JS2 is set for each of the plurality of documents DC by the second setting processing section 113. The setting value of the third setting item JS3 is set for each of the plurality of documents DC by the third setting processing section 114.

Next, first setting items JS1 will be further described with reference to FIG. 3. FIG. 3 is a diagram illustrating an example of the setting items JS included in the first category CT1.

FIG. 3 illustrates a first table TBL1 stored in the setting item storage section 118. The first table TBL1 shows an example of the setting items JS included in the first category CT1.

In the first table TBL1, the setting items JS and setting conditions CS are described from the left side to the right side. The setting conditions CS include settability AB, a default value DF, and a category CT.

In the category CT corresponding to each setting item JS shown in the first table TBL1, “1” is described and indicates that each setting item JS is a setting item JS included in the first category CT1, that is, the first setting item JS1.

The settability AB indicates whether or not setting by a user's operation is possible. In the settability AB corresponding to each first setting item JS1 shown in the first table TBL1, “○” is indicated, which shows that each setting item JS can be set by a user's operation.

In the default value DF, “setting for first document” is described. This indicates that, as described above, the first setting processing section 112 sets, for the first setting item JS1 of each of the plurality of documents DC, the setting value of the first setting item JS1 of the document DC that the user has selected at the very beginning when selecting the plurality of documents DC to be subjected to combined printing.

The first setting items JS1 shown in the first table TBL1 include, for example, “stamp”, “date printing”, and “page printing”.

The “stamp” indicates that a stamp such as a so-called “confidential” stamp is to be printed in a predetermined size at a predetermined position in an upper margin of the recording medium P, for example.

The “date printing” indicates that characters indicating a date of the printing are to be printed in a predetermined size at a predetermined position in a lower margin of the recording medium P, for example.

The “page printing” indicates that characters indicating a page in the document DC are to be printed in a predetermined size at a predetermined position in the lower margin of the recording medium P, for example.

Next, second setting items JS2 and third setting items JS3 will be further described with reference to FIG. 4. FIG. 4 is a diagram illustrating an example of the setting item JS included in the second category CT2 or the third category CT3.

FIG. 4 illustrates a second table TBL2 stored in the setting item storage section 118. The second table TBL2 shows an example of the setting items JS included in the second category CT2 or the third category CT3.

In the second table TBL2, the setting items JS and the setting conditions CS are described from the left side to the right side. The setting conditions CS include settability AB, a default value DF, and a category CT.

In the category CT corresponding to each setting item JS shown in the second table TBL2, “2” or “3” is described and indicates that each setting item JS is a setting item JS included in the second category CT2 or the third category CT3.

The settability AB indicates whether or not setting by a user's operation is possible.

In the settability AB corresponding to each second setting item JS2 shown in the second table TBL2, “○” is indicated, which shows that each second setting item JS2 can be set by a user's operation.

In the settability AB corresponding to each third setting item JS3 shown in the second table TBL2, “-” is indicated, which shows that each third setting item JS3 cannot be set by a user's operation.

In a case where a setting item JS is a second setting item JS2, the default value DF corresponding to each second setting item JS2 is described in the field of the default value DF.

In a case where a setting item JS is a third setting item JS3, the default value DF corresponding to each third setting item JS3 is not described in the field of the default value DF.

The second setting items JS2 shown in the second table TBL2 include, for example, “number of copies”, “stapling”, and “punching”.

The “number of copies” indicates the number of print copies of a plurality of documents DC to be subjected to combined printing.

The “stapling” indicates whether or not the recording media P are to be stacked for each set and end portions of the recording media P on one side are to be stapled for each set. This processing is executed by the stapler of the post-processing device 17.

The “punching” indicates whether or not to punch a punch hole at an end portion of each recording medium P on one side. This processing is executed by the puncher of the post-processing device 17.

As described above, the second setting processing section 113 sets the setting value of the second setting item JS2 to the default value DF. Thus, in a case where the setting item JS is the “number of copies”, for example, the setting value of the setting item JS is set to “1”, which is the default value DF. In addition, in a case where the setting item JS is “stapling” or “punching”, for example, the setting value of the setting item JS is set to “OFF”, which is the default value DF.

The third setting items JS3 shown in the second table TBL2 include, for example, “magnification”, “page consolidation”, and “sorting”.

The “magnification” indicates an enlargement/reduction magnification of an image to be formed on the recording medium P.

The “page consolidation” indicates that images on a plurality of pages are to be formed on one recording medium P. The “page consolidation” includes so-called “2 in 1”. The “2 in 1” indicates that images on two pages are reduced in size and are printed on one recording medium P.

The “sorting” indicates processing of stacking the recording media P for each set. The “sorting” is executed by the sorter of the post-processing device 17.

As described above, the third setting processing section 114 holds the setting value of the third setting item JS3.

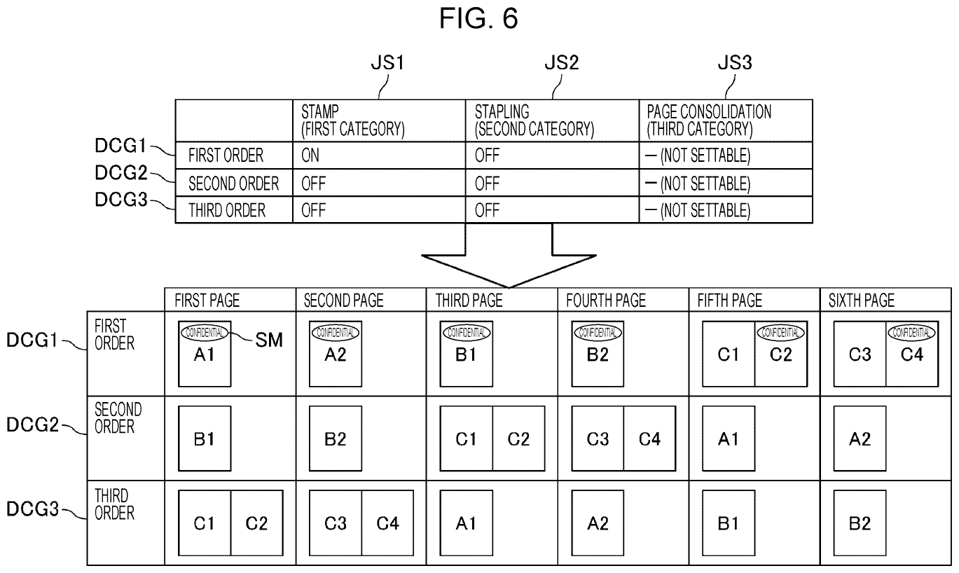

A specific example of the third setting processing section 114 will be further described with reference to FIG. 6.

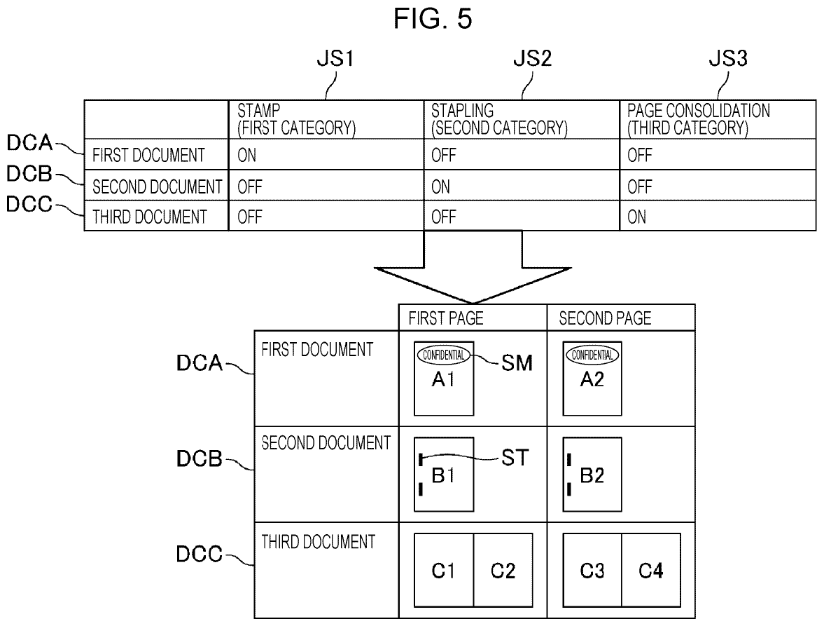

Next, a relationship between processing conditions and processing results in a case where each of the first document DCA, the second document DCB, and the third document DCC is individually printed will be described with reference to FIG. 5. FIG. 5 is a diagram illustrating an example of processing conditions and processing results in the case of individual printing.

Note that the “individual printing” indicates that the first document DCA, the second document DCB, and the third document DCC are individually printed. In a case where the user of the personal computer 2 provides an instruction to print the first document DCA, the second document DCB, and the third document DCC at mutually different timings, for example, the “individual printing” is executed.

The upper portion of FIG. 5 illustrates an example of processing conditions for each of the first document DCA, the second document DCB, and the third document DCC. The processing conditions include “stamp” which is an example of the first setting item JS1, “stapling” which is an example of the second setting item JS2, and “page consolidation” which is an example of the third setting item JS3.

As for the processing conditions for the first document DCA, the “stamp” is set to “ON”, the “stapling” is set to “OFF”, and the “page consolidation” is set to “OFF”.

As for the processing conditions for the second document DCB, the “stamp” is set to “OFF”, the “stapling” is set to “ON”, and the “page consolidation” is set to “OFF”.

As for the processing conditions for the third document DCC, the “stamp” is set to “OFF”, the “stapling” is set to “OFF”, and the “page consolidation” is set to “ON”.

The lower portion of FIG. 5 illustrates an example of processing results for each of the first document DCA, the second document DCB, and the third document DCC. Note that a case where each of the first document DCA, the second document DCB, and the third document DCC is constituted by two pages will be described in FIG. 5.

Since the “stamp” for the first document DCA is set to “ON”, an image of a stamp SM is printed on each of the first page and the second page. The characters “A1” described on the first page of the first document DCA indicate a document image on the first page of the first document DCA. The characters “A2” described on the second page of the first document DCA indicate a document image on the second page of the first document DCA.

Since the “stapling” for the second document DCB is set to “ON”, the first page and the second page are stapled with staples ST. For example, the first page and the second page are stapled with the staples ST at two locations in left margins of the recording media P. The characters “B1” described on the first page of the second document DCB indicate a document image on the first page of the second document DCB. The characters “B2” described on the second page of the second document DCB indicate a document image on the second page of the second document DCB.

Since the “page consolidation” for the third document DCC is set to “ON”, an image on the first page and an image on the second page of the third document DCC are printed on the first page, and an image on the third page and an image on the fourth page of the third document DCC are printed on the second page, for example. The characters “C1” described on the left side on the first page of the third document DCC indicate the document image on the first page of the third document DCC. The characters “C2” described on the right side on the first page of the third document DCC indicate the document image on the second page of the third document DCC. The characters “C3” described on the left side on the second page of the third document DCC indicate the document image on the third page of the third document DCC. The characters “C4” described on the right side on the second page of the third document DCC indicate the document image on the fourth page of the third document DCC.

Next, a relationship between processing conditions and processing results in a case where the first document DCA, the second document DCB, and the third document DCC are subjected to combined printing will be described with reference to FIG. 6. FIG. 6 is a diagram illustrating an example of processing conditions and processing results in the case of combined printing.

Note that the first document DCA described in FIG. 6 is the same document as the first document DCA described in FIG. 5. Also, the second document DCB described in FIG. 6 is the same document as the second document DCB described in FIG. 5. In addition, the third document DCC described in FIG. 6 is the same document as the third document DCC described in FIG. 5.

The upper portion of FIG. 6 illustrates an example of processing conditions for the first document DCA, the second document DCB, and the third document DCC.

A first order DCG1 indicates a case where the user of the personal computer 2 has selected the first document DCA, the second document DCB, and the third document DCC in this order.

In this case, the setting value of the first setting item JS1 of the first document DCA is set by the first setting processing section 112. In other words, the “stamp”, which is an example of the first setting item JS1, is set to “ON”. Furthermore, the setting value of the second setting item JS2 is set to the default value DF of the second setting item JS2 by the second setting processing section 113. In other words, the “stapling”, which is an example of the second setting item JS2, is set to “OFF”. Furthermore, the setting value of the third setting item JS3 is held to be the setting value of the third setting item JS3 of each of the first document DCA, the second document DCB, and the third document DCC by the third setting processing section 114. In other words, the “page consolidation”, which is an example of the third setting item JS3, is set to “OFF” for the first document DCA and the second document DCB and is set to “ON” for the third document DCC.

The lower portion of FIG. 6 illustrates an example of processing results for the first document DCA, the second document DCB, and the third document DCC.

In the case of the first order DCG1, the first page and the second page are the processing results of the first document DCA, the third page and the fourth page are the processing results of the second document DCB, and the fifth page and the sixth page are the processing results of the third document DCC.

Since the “stamp”, which is an example of the first setting item JS1, is set to “ON”, the image of the stamp SM is printed on all the pages from the first page to the sixth page. In addition, since the “stapling”, which is an example of the second setting item JS2, is set to “OFF”, the stapling processing is not performed on all the pages from the first page to the sixth page. In addition, the “page consolidation”, which is an example of the third setting item JS3, is set to “OFF” for the first document DCA and the second document DCB and is set to “ON” for the third document DCC. Therefore, the document image on each page of each of the first document DCA and the second document DCB is printed on all the pages from the first page to the fourth page. The document image on the first page of the third document DCC and the document image on the second page of the third document DCC are printed on the fifth page, and the document image on the third page of the third document DCC and the document image on the fourth page of the third document DCC are printed on the sixth page.

A second order DCG2 illustrated in the upper portion of FIG. 6 indicates a case where the user of the personal computer 2 has selected the second document DCB, the third document DCC, and the first document DCA in this order.

In this case, the setting value of the first setting item JS1 of the second document DCB is set by the first setting processing section 112. In other words, the “stamp”, which is an example of the first setting item JS1, is set to “OFF”. Furthermore, the setting value of the second setting item JS2 is set to the default value DF of the second setting item JS2 by the second setting processing section 113. In other words, the “stapling”, which is an example of the second setting item JS2, is set to “OFF”. Furthermore, the setting value of the third setting item JS3 is held to be the setting value of the third setting item JS3 of each of the first document DCA, the second document DCB, and the third document DCC by the third setting processing section 114. In other words, the “page consolidation”, which is an example of the third setting item JS3, is set to “OFF” for the first document DCA and the second document DCB and is set to “ON” for the third document DCC.

The lower portion of FIG. 6 illustrates an example of processing results of the second document DCB, the third document DCC, and the first document DCA.

In the case of the second order DCG2, the first page and the second page are the processing results of the second document DCB, the third page and the fourth page are the processing results of the third document DCC, and the fifth page and the sixth page are the processing results of the first document DCA.

Since the “stamp”, which is an example of the first setting item JS1, is set to “OFF”, the image of the stamp SM is not printed on all the pages from the first page to the sixth page. In addition, since the “stapling”, which is an example of the second setting item JS2, is set to “OFF”, the stapling processing is not performed on all the pages from the first page to the sixth page. In addition, the “page consolidation”, which is an example of the third setting item JS3, is set to “OFF” for the first document DCA and the second document DCB and is set to “ON” for the third document DCC. Therefore, the document image on each page of the second document DCB is printed on the first page and the second page. Furthermore, the document image on the first page of the third document DCC and the document image on the second page of the third document DCC are printed on the third page, and the document image on the third page of the third document DCC and the document image on the fourth page of the third document DCC are printed on the fourth page. The document image on each page of the first document DCA is printed on the fifth page and the sixth page.

A third order DCG3 illustrated in the upper portion of FIG. 6 indicates a case where the user of the personal computer 2 has selected the third document DCC, the first document DCA, and the second document DCB in this order.

In this case, the setting value of the first setting item JS1 of the third document DCC is set by the first setting processing section 112. In other words, the “stamp”, which is an example of the first setting item JS1, is set to “OFF”. Furthermore, the setting value of the second setting item JS2 is set to the default value DF of the second setting item JS2 by the second setting processing section 113. In other words, the “stapling”, which is an example of the second setting item JS2, is set to “OFF”. Furthermore, the setting value of the third setting item JS3 is held to be the setting value of the third setting item JS3 of each of the first document DCA, the second document DCB, and the third document DCC by the third setting processing section 114. In other words, the “page consolidation”, which is an example of the third setting item JS3, is set to “OFF” for the first document DCA and the second document DCB and is set to “ON” for the third document DCC.

The lower portion of FIG. 6 illustrates an example of processing results of the third document DCC, the first document DCA, and the second document DCB.

In the case of the third order DCG3, the first page and the second page are the processing results of the third document DCC, the third page and the fourth page are the processing results of the first document DCA, and the fifth page and the sixth page are the processing results of the second document DCB.

Since the “stamp”, which is an example of the first setting item JS1, is set to “OFF”, the image of the stamp SM is not printed on all the pages from the first page to the sixth page. In addition, since the “stapling”, which is an example of the second setting item JS2, is set to “OFF”, the stapling processing is not performed on all the pages from the first page to the sixth page. In addition, the “page consolidation”, which is an example of the third setting item JS3, is set to “OFF” for the first document DCA and the second document DCB and is set to “ON” for the third document DCC. Therefore, the document image on the first page of the third document DCC and the document image on the second page of the third document DCC are printed on the first page, and the document image on the third page of the third document DCC and the document image on the fourth page of the third document DCC are printed on the second page. Also, the document image on each page of the first document DCA is printed on the third page and the fourth page. The document image on each page of the second document DCB is printed on the fifth page and the sixth page.

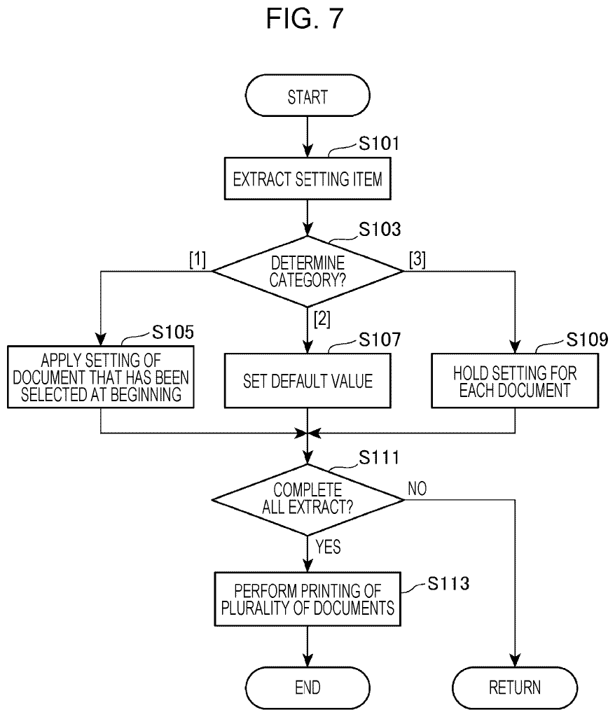

Next, processing performed by the control section 11 in the present embodiment will be described with reference to FIG. 7. FIG. 7 is a flowchart illustrating an example of the processing performed by the control section 11.

As illustrated in FIG. 7, first, the determination section 111 sequentially extracts each of a plurality of setting items JS defining content of processing to be performed by the printer 1 in Step S101.

Next, in Step S103, the determination section 111 determines which of the first setting item JS1, the second setting item JS2, and the third setting item JS3 each setting item JS extracted in Step S101 is with reference to the table TBL stored in the setting item storage section 118.

In a case where the determination section 111 determines that the extracted setting item JS is the first setting item JS1 (Step S103; “1”), the processing proceeds to Step S105.

Then, in Step S105, the first setting processing section 112 sets, for the first setting item JS1 of each of the plurality of documents DC, the setting value of the first setting item JS1 of the document DC that the user has selected at the very beginning when, for example, selecting the plurality of documents DC to be subjected to combined printing. Thereafter, the processing proceeds to Step S111.

In a case where the determination section 111 determines that the extracted setting item JS is the second setting item JS2 (Step S103; “2”), the processing proceeds to Step S107.

Then, in Step S107, the second setting processing section 113 sets the default value DF of the second setting item JS2 for the second setting item JS2 of each of the plurality of documents DC. Thereafter, the processing proceeds to Step S111.

In a case where the determination section 111 determines that the extracted setting item JS is the third setting item JS3 (Step S103; “3”), the processing proceeds to Step S109.

In Step S109, the third setting processing section 114 holds the setting value of the third setting item JS3 of each of the plurality of documents DC. Thereafter, the processing proceeds to Step S111.

Next, in Step S111, the determination section 111 determines whether or not all of the plurality of setting items JS have been extracted.

In a case where the determination section 111 determines that all of the plurality of setting items JS have not been extracted (Step S111; NO), the processing returns to Step S101. In a case where the determination section 111 determines that all of the plurality of setting items JS have been extracted (Step S111; YES), the processing proceeds to Step S113.

Then, in Step S113, the print execution section 115 executes combined printing of the plurality of documents DC. Thereafter, the processing ends.

### Configurations and Effects

As described above with reference to FIGS. 1 to 7, the control section 11 according to the present embodiment is a control section 11 that controls combined printing of the plurality of documents DC and includes the first setting processing section 112 that sets, in regard to the first setting item JS1, which is a setting item included in the first category CT1, from among the plurality of setting items JS defining content of the processing to be performed on the documents DC, the setting value of the first setting item JS1 of any one document DC from among the plurality of documents DC for the first setting item JS1 of each of the plurality of documents DC and the second setting processing section 113 that sets, in regard to the second setting item JS2, which is a setting item JS included in the second category CT2 that is different from the first category CT1, from among the plurality of setting items JS, the default value DF of the second setting item JS2 for the second setting item JS2 of each of the plurality of documents DC.

According to this configuration, in regard to the first setting item JS1, which is the setting item included in the first category CT1, the setting value of the first setting item JS1 of any one document DC from among the plurality of documents DC is set for the first setting item JS1 of each of the plurality of documents DC. Therefore, it is possible to obtain a printing result desired by the user by appropriately setting the first setting item JS1. As for the second setting item JS2, which is the setting item JS included in the second category CT2 that is different from the first category CT1, the default value DF of the second setting item JS2 is set for the second setting item JS2 of each of the plurality of documents DC. Therefore, it is possible to obtain a printing result desired by the user by appropriately setting the second setting item JS2 and the default value DF.

Furthermore, in the control section 11 according to the present embodiment, the first setting processing section 112 sets, for the first setting item JS1 of each of the plurality of documents DC, the setting value of the first setting item JS1 of the document DC that has been selected at the very beginning when the plurality of documents DC has been selected.

According to this configuration, the setting value of the first setting item JS1 of the document DC that has been selected at the very beginning when the plurality of documents DC has been selected is set for the first setting item JS1 of each of the plurality of documents DC. Therefore, it is possible to obtain a printing result desired by the user by appropriately determining the document DC to be selected at the very beginning when the plurality of documents DC is selected.

Also, the control section 11 according to the present embodiment includes the third setting processing section 114 that holds, in regard to the third setting item JS3, which is the setting item JS included in the third category CT3 that is different from the first category CT1 and the second category CT2, from among the plurality of setting items JS, the setting value of the third setting item JS3 of each of the plurality of documents DC.

According to this configuration, in regard to the third setting item JS3, which is the setting item JS included in the third category CT3 that is different from the first category CT1 and the second category CT2, from among the plurality of setting items JS, the setting value of the third setting item JS3 of each of the plurality of documents DC is held. Therefore, it is possible to obtain a printing result desired by the user by appropriately setting the third setting item JS3.

In addition, the control section 11 according to the present embodiment includes the third setting processing section 114 that sets, in regard to the third setting item JS3, which is the setting item JS included in the third category CT3 that is different from the first category CT1 and the second category CT2, from among the plurality of setting items JS, the setting value of the third setting item JS3 of each of the plurality of documents DC on the basis of a user's operation.

According to this configuration, in regard to the third setting item JS3, which is the setting item included in the third category CT3 that is different from the first category CT1 and the second category CT2, from among the plurality of setting items JS, the setting value of the third setting item JS3 of each of the plurality of documents DC is set on the basis of the user's operation. It is possible to obtain a printing result desired by the user by the user setting the setting value of the third setting item JS3 to a desired setting value.

Furthermore, the control section 11 according to the present embodiment includes the third setting processing section 114 that selects, for the third setting item JS3, which is the setting item JS included in the third category CT3 that is different from the first category CT1 and the second category CT2, from among the plurality of setting items JS, whether to set the setting value of the third setting item JS3 on the basis of a user's operation, whether to set the setting value of the third setting item JS3 to the default value DF, or whether to hold the setting value of the third setting item JS3 of each of the plurality of documents DC.

According to this configuration, in regard to the third setting item JS3, which is the setting item JS included in the third category CT3 that is different from the first category CT1 and the second category CT2, from among the plurality of setting items JS, whether to set the setting value of the third setting item JS3 on the basis of the user's operation, whether to set the setting value of the third setting item JS3 to the default value DF, or whether to hold the setting value of the third setting item JS3 of each of the plurality of documents DC is selected. Therefore, it is possible to select a method of setting the setting value of the third setting item JS3 and to thereby improve convenience of the user.

In addition, the control section 11 according to the present embodiment includes the setting item storage section 118 that stores which of the first setting item JS1, the second setting item JS2, or the third setting item JS3 each of the plurality of setting items JS is.

According to this configuration, the setting item storage section 118 stores which of the first setting item JS1, the second setting item JS2, or the third setting item JS3 each of the plurality of setting items JS is. Therefore, the user can easily check which of the first setting item JS1, the second setting item JS2, or the third setting item JS3 each of the plurality of setting items JS is. Therefore, it is possible to improve convenience of the user.

A print control method according to the present embodiment includes: setting, in regard to the first setting item JS1, which is the setting item included in the first category CT1, from among the plurality of setting items JS defining content of processing to be performed on the documents DC, a setting value of the first setting item JS1 of any one document DC from among the plurality of documents DC for the first setting item JS1 of each of the plurality of documents DC; and setting, in regard to the second setting item JS2, which is the setting item JS included in the second category CT2 that is different from the first category CT1, from among the plurality of setting items JS, the default value DF of the second setting item JS2 for the second setting item JS2 for each of the plurality of documents DC.

The print control method according to the present embodiment has advantages that are similar to those of the control section 11 according to the present embodiment.

The control program 116 according to the present embodiment causes the processor 11A included in the control section 11 that controls combined printing of the plurality of documents DC to function as: the first setting processing section 112 that sets, in regard to the first setting item JS1, which is the setting item included in the first category CT1, from among the plurality of setting items JS defining content of processing to be performed on the documents DC, a setting value of the first setting item JS1 of any one document DC from among the plurality of documents DC for the first setting item JS1 of each of the plurality of documents DC; and the second setting processing section 113 that sets, in regard to the second setting item JS2, which is the setting item JS included in the second category CT2 that is different from the first category CT1, from among the plurality of setting items JS, the default value DF of the second setting item JS2 for the second setting item JS2 of each of the plurality of documents DC.

The control program 116 according to the present embodiment has advantages that are similar to those of the control section 11 according to the present embodiment.

### Other Embodiments

The present embodiment illustrates one aspect and can be appropriately modified and applied without departing from the gist.

Although the case where the printer 1 includes the post-processing device 17 has been described in the present embodiment, embodiments are not limited thereto. For example, the printer 1 may not include the post-processing device 17. In addition, the printer 1 may be a copying machine or a multifunction peripheral (MFP).

Although the case where the recording head 151 is an ink jet recording head has been described in the present embodiment, embodiments are not limited thereto. The recording head 151 may be, for example, a thermal head.

Although the case where the network NW is a LAN has been described in the present embodiment, embodiments are not limited thereto. The network NW may be, for example, a wide area network (WAN). Also, the network NW may be, for example, the Internet.

Although the first setting processing section 112 sets the setting value of the first setting item JS1 in the document data DD corresponding to the document DC that the user of the personal computer 2 has selected at the very beginning when selecting the plurality of documents DC to be subjected to combined printing for each of the plurality of documents DC in the present embodiment, embodiments are not limited thereto.

For example, the first setting processing section 112 may set a setting value of a first setting item JS1 in document data DD corresponding to a document DC that the user of the personal computer 2 has selected secondly from the beginning when selecting the plurality of documents DC to be subjected to combined printing for each of the plurality of documents DC.

Also, the first setting processing section 112 may select one document DC from among the plurality of documents DC to be subjected to combined printing and set a setting value of a first setting item JS1 in document data DD corresponding to the selected document DC for each of the plurality of documents DC on the basis of a user's operation, for example.

Although the case where the processor 11A included in the printer 1 executes the control program 116 stored in the memory 11B has been described in the present embodiment, embodiments are not limited thereto. The control program 116 can also be configured in the form of a recording medium that records the control program 116 in a computer-readable manner or a transmission medium that transmits the control program 116.

As the recording medium, it is possible to use a magnetic or optical recording medium or a semiconductor memory device. Examples of the recording medium include portable or fixed recording media such as a flexible disk, an HDD, a compact disk read only memory (CD-ROM), a digital versatile disk (DVD), a Blu-ray (registered trademark) Disc, a magneto-optical disc, a flash memory, and a card-type recording medium.

The recording medium may be a non-volatile storage device such as a RAM, a ROM, or an HDD which is an internal storage device included in the printer 1.

The functions of the control section 11 of the printer 1 may be implemented by one or more processors or a semiconductor chip. The control section 11 may be configured to further include a co-processor such as a System-on-a-Chip (SoC), a micro control unit (MCU), or an FPGA. The control section 11 may perform various kinds of control by causing both the CPU and the co-processor to cooperate with each other or by selectively using one of the CPU and the co-processor.

Each processing unit of the flowchart of FIG. 7 is expressed by dividing the processing of the control section 11 of the printer 1 in accordance with main content of processing for easy understanding, and embodiments are not limited by how to divide the processing units and how to call them. The processing units of the flowchart may be further divided into more processing units in accordance with content of the processing. Division may be performed such that one processing unit includes more processes. The order of the processing may be changed as appropriate without affecting the gist.

Each functional section illustrated in FIG. 2 indicates a functional configuration, and specific implementation is not particularly limited. It is not always necessary to mount hardware individually corresponding to each functional unit, and it is also possible to adopt a configuration in which one processor executes a program to implement functions of a plurality of functional units. In the above-described embodiment, some of the functions implemented by software may be implemented by hardware, or some of the functions implemented by hardware may be implemented by software. In addition, the specific detailed configuration of each of the other sections of the printer 1 can also be appropriately changed without departing from the gist.

What is claimed is:

1. A print control apparatus that controls combined printing of a plurality of documents, the print control apparatus comprising:
a first setting processing section configured to set, in regard to a first setting item, which is a setting item included in a first category, from among a plurality of setting items defining content of processing to be performed on the documents, a setting value of the first setting item of any one document from among the plurality of documents for the first setting item of each of the plurality of documents; and
a second setting processing section configured to set, in regard to a second setting item, which is a setting item included in a second category that is different from the first category, from among the plurality of setting items, a default value of the second setting item for the second setting item of each of the plurality of documents.

2. The print control apparatus according to claim 1, wherein the first setting processing section sets, for the first setting item of each of the plurality of documents, a setting value of the first setting item of a document that has been selected at a very beginning when the plurality of documents has been selected.

3. The print control apparatus according to claim 1, further comprising:
a third setting processing section configured to hold, in regard to a third setting item, which is a setting item included in a third category that is different from the first category and the second category, from among the plurality of setting items, a setting value of the third setting item of each of the plurality of documents.

4. The print control apparatus according to claim 1, further comprising:
a third setting processing section configured to set, in regard to a third setting item, which is a setting item included in a third category that is different from the first category and the second category, from among the plurality of setting items, a setting value of the third setting item of each of the plurality of documents, based on a user's operation.

5. The print control apparatus according to claim 1, further comprising:
a third setting processing section configured to select, in regard to a third setting item, which is a setting item included in a third category that is different from the first category and the second category, from among the plurality of setting items, whether to set a setting value of the third setting item, based on a user's operation, whether to set the setting value of the third setting item to a default value, or whether to hold the setting value of the third setting item of each of the plurality of documents.

6. The print control apparatus according to claim 3, further comprising:
a setting item storage section configured to store which of the first setting item, the second setting item, or the third setting item each of the plurality of setting items is.

7. A print control method for controlling combined printing of a plurality of documents, the method comprising:
setting, in regard to a first setting item, which is a setting item included in a first category, from among a plurality of setting items defining content of processing to be performed on the documents, a setting value of the first setting item of any one document from among the plurality of documents for the first setting item of each of the plurality of documents; and
setting, in regard to a second setting item, which is a setting item included in a second category that is different from the first category, from among the plurality of setting items, a default value of the second setting item for the second setting item of each of the plurality of documents.

8. A non-transitory computer-readable storage medium storing a program that causes a processor included in a print control apparatus that controls combined printing of a plurality of documents to function as:
a first setting processing section configured to set, in regard to a first setting item, which is a setting item included in a first category, from among a plurality of setting items defining content of processing to be performed on the documents, a setting value of the first setting item of any one document from among the plurality of documents for the first setting item of each of the plurality of documents; and
a second setting processing section configured to set, in regard to a second setting item, which is a setting item included in a second category that is different from the first category, from among the plurality of setting items, a default value of the second setting item for the second setting item of each of the plurality of documents.
